(19) United States
(12) Patent Application Publication
(10) Pub. No.: US 2016/0196764 A1
(43) Pub. Date: Jul. 7, 2016

(54) ALPHABET TEACHING AID

(71) Applicant: Alicia Silver, Haddon Heights, NJ (US)

(72) Inventor: Alicia Silver, Haddon Heights, NJ (US)

(21) Appl. No.: 14/846,458

(22) Filed: Sep. 4, 2015

Related U.S. Application Data
(63) Continuation of application No. 13/761,151, filed on Feb. 6, 2013, now abandoned.

(51) Int. Cl. G09B 17/00

(52) U.S. Cl. CPC G09B 17/00

(57) ABSTRACT

A teaching aid for children learning the alphabet of any language utilizing a combination of alpha characters each in a cluster with a word starting with the alpha character and a drawing that are drawn in a child's hand. A preferred configuration is an alphabet strip with irregular child drawn borders appearing on a substrate. The substrate may be a clear plastic of any outline but with the border and background as well as the clusters mechanically or electronically printed.

### CROSS-REFERENCE TO RELATED APPLICATIONS

This U.S. Non-Provisional Utility patent application claims priority from U.S. Provisional Patent No. 61/595,583, with Inventor Alicia Silver filed on 06, Feb. 2012.

This U.S. Non-Provisional Utility patent application claims priority from U.S. Provisional Patent No. 61/684,728, with Inventor Alicia Silver filed on 18 Aug. 2012.

### BACKGROUND

Research has shown that a child will transition readily into the first grade if they can recite and identify all of the letters of the alphabet and associate each letter with the name of a familiar object. Currently available alphabet teaching aids are cute and decorative so the parents will buy them. The current designs give little regard to supporting an organized, class room proven, methodology evoking the intellectual impressions for learning that will get them into the first grade.

### SUMMARY OF THE PRESENT INVENTION

The preferred embodiment of the present invention overcomes the short comings of other alphabet teaching aids by application of the following core principles:
Index the printed material with an alpha indicia to evoke the intellectual impression of teaching one alpha at a time;
Providing a child's hand drawn graphic indicia to evoke an intellectual impression establishing a comfort level with the student;
Placing the hand drawn graphic indicia in the proximity of the indexed alpha indicia to evoke the intellectual impression of association between the alpha indicia and the graphic indicia;
Printing a combination of alphas in a child's hand in a third indicia to evoke an intellectual impression reinforcing the comfort level with the student and associating the combination of alpha indicias with the graphic indicia;
Mechanically reproducing another form of the alpha indicia near the child's hand drawn indicia;
Optionally, Mechanically reproduce an indicia of child's hand lettering to evoke an intellectual impression connecting pronunciation to the graphic indicia;
an equivalent but different alpha indicia near the indexed alpha indicia to evoke the intellectual impression of differing forms of the alpha indicia; Print any additional graphic indicia, decorative indicia or embellishment indicia away from any of the five aforementioned indicia to prevent student distractions or confusion.
Cutting of the periphery of the printed matter in an irregular child's cut outline to further evoke the intellectual impression of child comfort.
The first element is drawn as an outline for the child to color.
One or more first elements are of people, possessions or places familiar to the specific child being taught the alphabet.
The teaching aid is mechanically or electronically reproduced on a colored background that is also mechanically or electronically reproduced and bounded by the outline on a clear or translucent substrate.

Additional optional features of the preferred embodiment are:
Adding an alpha indicia that evokes the intellectual impression of syllables;
Adding an alpha indicia that evokes the intellectual impression of pronunciation;
Adding mechanically reproduced child-like printed indicia to evoke the intellectual impression of further uses of the alpha indicia;
Adding an product name indicia that evokes the intellectual impression of child ownership;
Further evoke the intellectual impression of child ownership by adding a black outlined graphic indicia for the student to color;
And still further evoke the intellectual impression of child ownership by adding custom graphic indicia of the child's family, pets or family members.

### BRIEF DESCRIPTION OF THE SEVERAL VIEWS OF THE DRAWING(S)

FIG. 1 is a plan view of the preferred configuration of the present invention.

FIGS. 2, 3, and 4 are plan views of the preferred embodiment showing key characteristics.

FIG. 5 is a key to the drawing reference codes identifying characteristics of the preferred embodiment of the present invention.

FIG. 6 Is a block diagram showing the method of using the second embodiment of the present invention.

### DETAILED DESCRIPTION OF THE PREFERRED EMBODIMENT OF THE PRESENT INVENTION

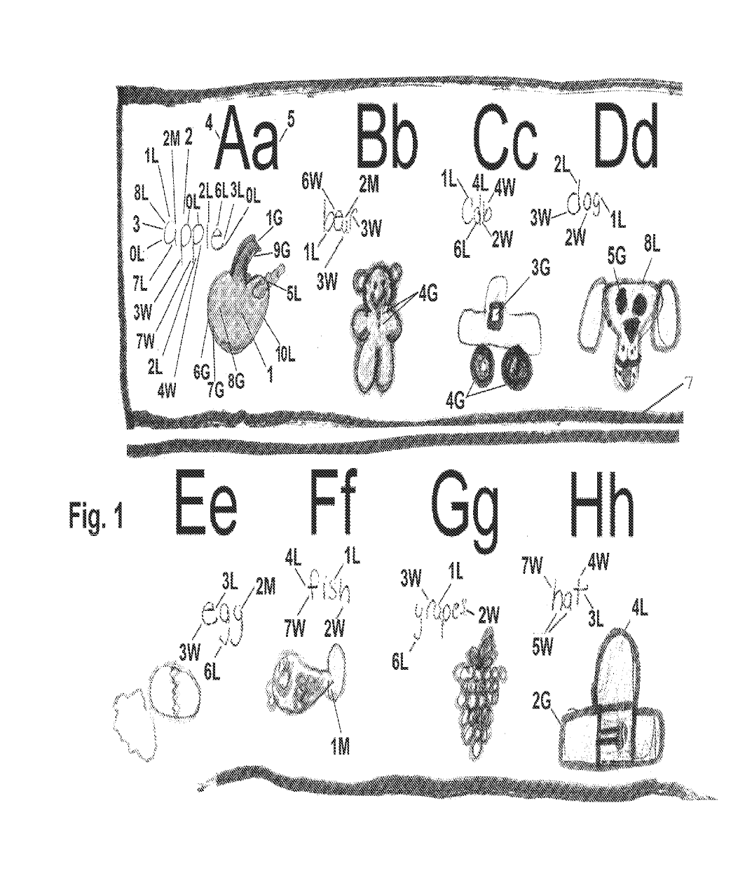

FIG. 1 shows the preferred configuration of the present invention as an alphabet teaching aid with a child drawn outline and child cut periphery for demonstrating the alphabet with a child printed word starting with each letter and a corresponding child made drawing illustrating each word.

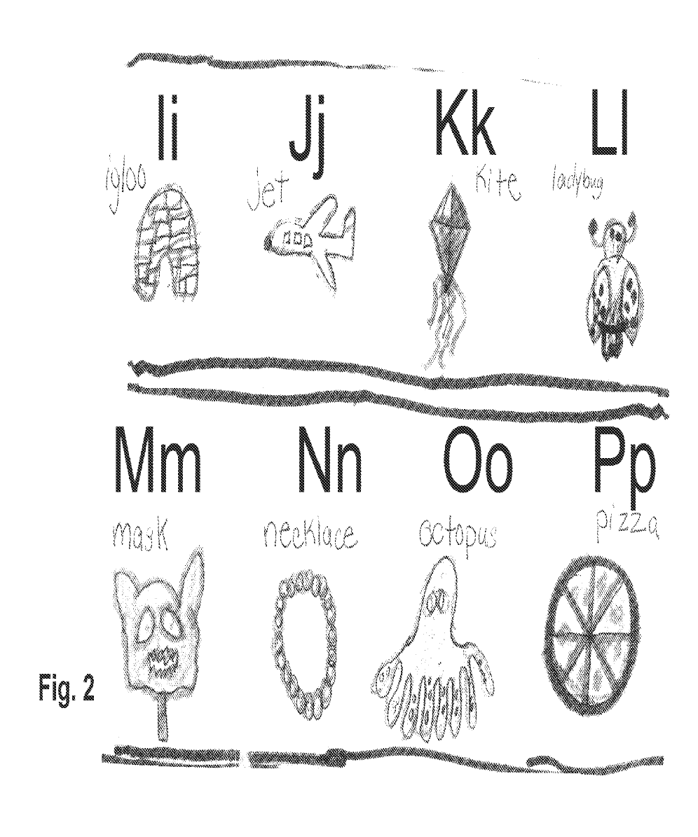

FIG. 2 shows the character and graphic grouping of the preferred embodiment of the present invention as it can be applied to any of a number of products and media to aid in teaching the alphabet. The subject of the hand drawn object 1 in the present invention can be chosen from objects familiar to societies living on any part of the planet or within the grasp of students from any socio-economic status within a society. The hand drawn word 2 can be from any type of writing whether character, glyph, pictogram or any other language base, so long as it describes the hand drawn object 1. The featured part 3 of the word 2, which in the preferred embodiment is the first letter, can alternatively be a syllable, sound or some component of the word that is distinguishable in a mechanically reproduced form which in the preferred embodiment is a capital letter 4 and lower case letter 5 in a popular sans-serif typeface. The graphic components of the preferred embodiment can be arranged in any position relative to each other however, for maximum teaching impact the eye of the student should start at the hand drawn object, progress to the hand drawn word and end at the mechanically reproduced letters 4 and 5. Furthermore, the preferred embodiment can be applied to the gamut of printed products including but not limited to alphabet strips, cards, posters, books and magazines. Electronic media is also well suited to bringing the preferred embodiment of the present invention to the student such as but not limited to the Internet, television, films, videos and facsimile. The delivery of Internet and electronic media to the student could be but not limited to hand held cell phones, smart-phones, electronic tablets, portable computers. Also, the graphic elements of the present invention may be presented in three-dimension or with motion. Picture for a moment a student watching a three dimensional image of the apple that enlarges and rotates to draw the student's attention followed by the apple shrinking and the word apple scrolling across the screen as it gets larger and is accompanied by a verbalization of the word. Then the word apple shrinks except for the letter “a” that appears for a moment and then alternately flashes on the screen accompanied by vocalization of the “a” sound. Finally attention is drawn to the mechanically reproduced letters that arrive whirling in a tornado with the capital letter 4 being verbalized by a low pitched voice and the lower case letter 5 being vocalized by a high pitched voice. This dramatization meets the requirements of the present invention by presenting the apple which is familiar to the student first, then drawing attention to the hand written word apple, followed by attention to the first letter in apple “a” followed by the mechanically reproduced letters. The order in which any of the graphics herein described may be changed so long as they appear in essentially a line or a cluster in proximity to the other graphics associated with the same letter of the alphabet.

The sixth core element of the present invention is that of space. Space is represented by a box or border surrounding the other five core elements. The square is clear of any other graphic that could distract the student from focus on learning the letters of the alphabet or even worse from believing that the letter being learned always includes the other graphic. The core element of space being missing is a major cause of the poor teaching results achieved using commercially available alphabet teaching aids available today.

Lastly, the present invention can be practiced in the teaching environments of the future because the preferred embodiment of the present invention can be applied to interactive learning using any of the aforementioned devices or media, for instance the student can be supplied with an outline of the hand drawn apple for the student to color in any media, lines can be supplied across the virtual or physical media on which to hand draw the word 2 and its first hand drawn character 1 and a key board, rubber stamp, tracing template or other means of producing the mechanically reproduced characters 4 and 5. Further, student generated images can be transferred from physical to virtual media using a cell phone camera and visa versa by an electronic printer but not limited to these devices.

What ever the device or the media one can quickly determine if the preferred embodiment of the present invention is being practiced by answering yes to the following questions:
Is the object familiar to a student from their experience?
Is the drawing technique of the object within the ability off a 4-6 year old?
Is the word the common name of the object?
Is the lettering technique of the word within the ability off a 4-6 year old?
Is the first letter of the word also presented as the upper and or lower case mechanically reproduced letter?
Are all of the graphics associated with the same letter of the alphabet in essentially a line or a cluster?
Optionally is the name of the object mechanically reproduced with syllable and pronunciation markings?
Is there clear space around the object, word and mechanically reproduced letters to prevent distractions or confusion?

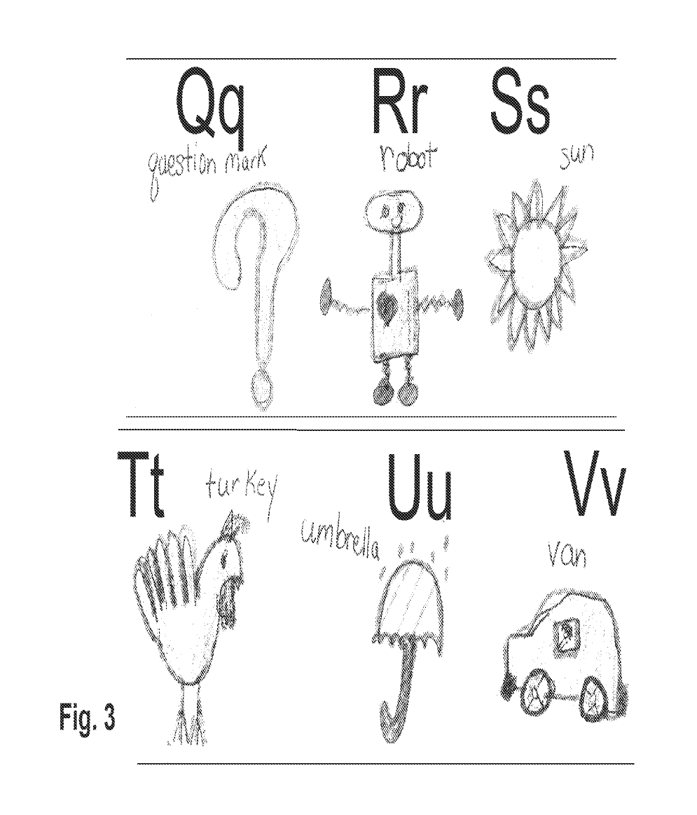

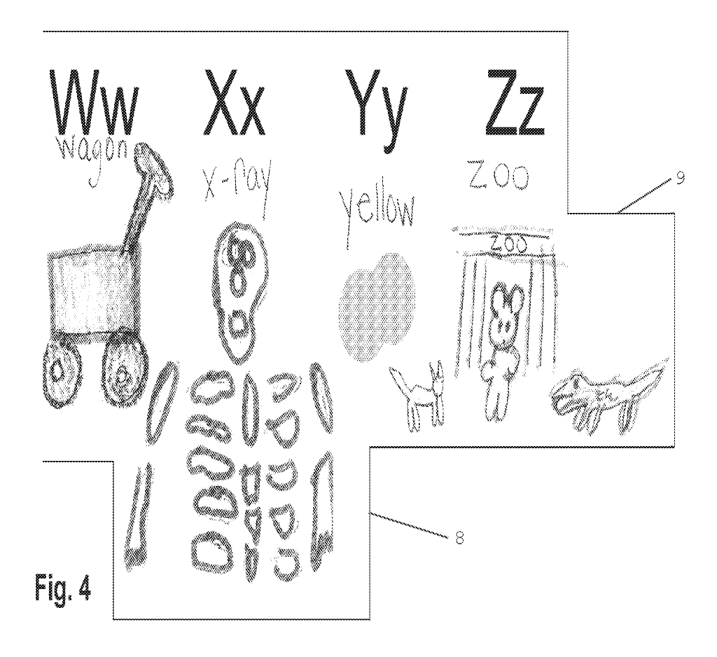

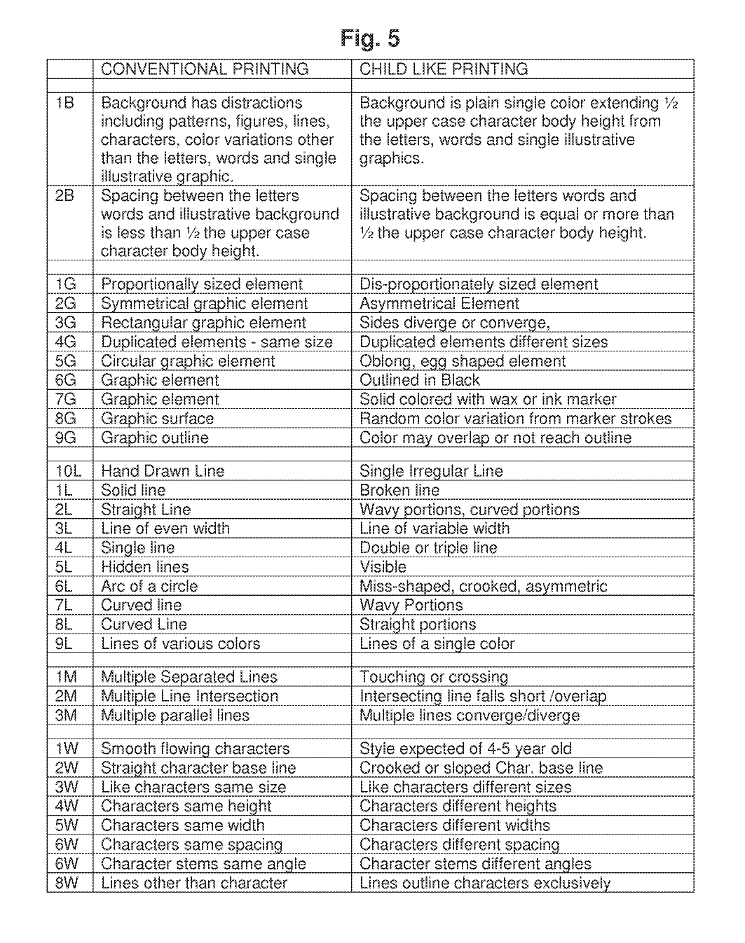

Should the answer to the questions concerning the lettering ability of a 4-6 year old be in question, FIGS. 3, 4 and 5 are presented for border line cases where skill level is not easily determined. The drawing reference numbers in FIGS. 3 and 5 correspond to the drawing reference numbers in the left hand column of FIG. 4. The middle column describes the drawing characteristic that a trained adult would apply to draw the object or letter the characters. The right hand column describes the drawing and lettering characteristic that can be expected when done by a 4-6 year old. If one goes over several characters or objects and marks each of the characteristics in the middle column and each of the characteristics that are in the right hand column and the majority of the characteristics are in the right hand column the drawing is considered to be at the highest level achievable by a 4-6 year old. The average 4-6 year old will be hard pressed to achieve more than a few characteristics in the middle column with their lettering and drawing skill level.

According to a second embodiment of the present invention, a printed strip can have the letters are in alphabetical order. However, the location of the preferred embodiments of the present invention may be any orientation and the strip may take any shape. The strip of the second embodiment of the present invention adds a hand drawn border 7 to further evoke the intellectual impression of comfort to a child with a child drawn, child friendly and comfortable teaching aid. To further this theme the outline of the strip is irregular and has vertically protruding areas 8 along the long horizontal edge and horizontal protruding areas 9 along the shorter vertical edge. Although the alphabet strip is often implemented in strip form the second embodiment of the present invention can also be applied on children's furniture, blackboards, picture frames, decorative wall trim, and the like, as well as used either as the focus of virtual media or a supplemental rolling banner across the bottom of the screen during children's interaction with virtual media. Even scent can be deployed on the drawing boards so the student's interaction could include olfactory feedback while learning the alphabet.

Referring to FIG. 5, various distinctions between the present invention and conventional alphabet strips are noted. The table below reflects these distinctions.

| | CONVENTIONAL PRINTING | CHILD LIKE PRINTING |
|---|---|---|
| 1B | Background has distractions including | Background is plain single color extending ½ the |
| | patterns, figures, lines, characters, color | upper case character body height from the letters, |
| | variations other than the letters, words | words and single illustrative graphics. |
| | and single illusrative graphic. | |
| 2B | Spacing between the letters words and | Spacing between the letters words and illustrative |
| | illustrative background is less than ½ | background is equal or more than ½ |
| | the upper case characer body height. | the upper case character body height. |
| 1G | Proportionally sized graphic element | Dis-proportionately sized element |
| 2G | Symmetrical graphic element | Asymmetrical element |
| 3G | Rectangular graphic element | Sides diverge or converge |
| 4G | Multiple graphic elements-same size | Different sizes |
| 5G | Circular graphic element | Oblong, egg shpaed element |
| 6G | Graphic element | Outlined in Black |
| 7G | Graphic element | Solid colored with wax or ink marker |
| 8G | Graphic surface | Random color variation from marker strokes |
| 9G | Graphic outline | Color may overlap or not reach outline |
| 0L | Hand Drawn Line | Single Irregular Line |
| 1L | Solid line | Broken line |
| 2L | Straight Line | Wavy portions, curved portions |
| 3L | Line of even width | Line of variable width |
| 4L | Single line | Double or triple line |
| 5L | Hidden lines | Visible |
| 6L | Arc of a circle | Miss-shaped, crooked, asymmetric |
| 7L | Curved line | Wavy Portions |
| 8L | Curved Line | Straight portions |
| 9L | Lines of various colors | Lines of a single color |
| 1M | Multiple Separated Lines | Touching or crossing |
| 2M | Multiple Line Intersection | Multiple lines converge/diverge |
| 1W | Smooth flowing characters | Style expected of 4-5 year old |
| 2W | Straight character base line | Crooked or sloped Char. Base line |
| 3W | Like characters same size | Like characters different sizes |
| 4W | Charcters same height | Characters different heights |
| 5W | Characters same width | Characters different widths |
| 6W | Characters same spacing | Characters different spacing |
| 7W | Character stems same angle | Character stems different angles |
| 8W | Lines other than character | Lines outside characters exclusively |

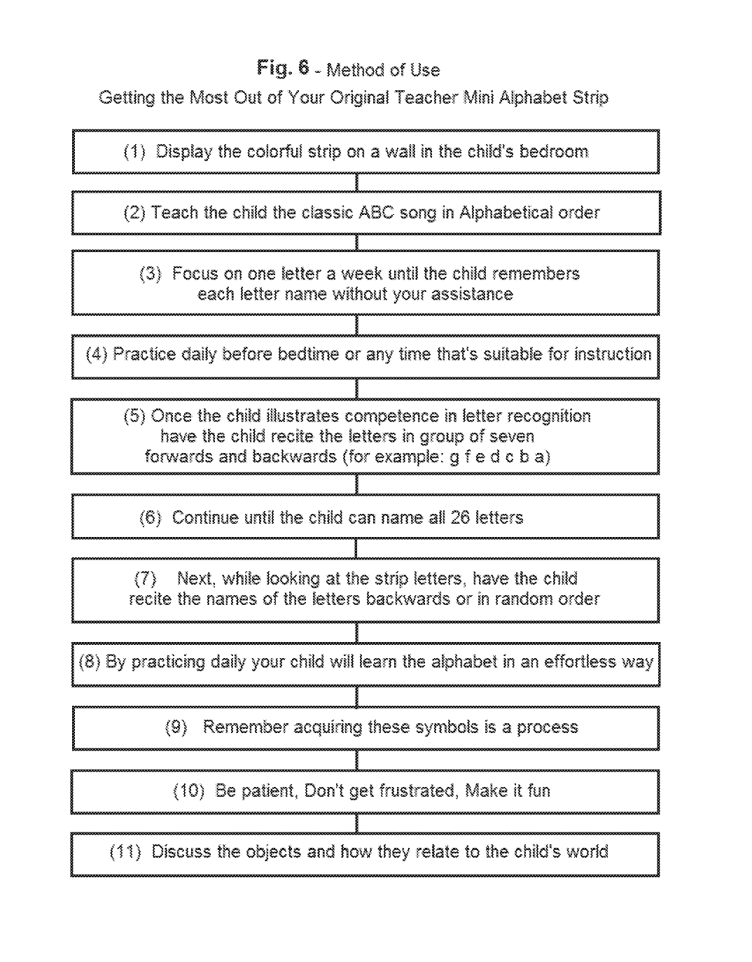

FIG. 6 is a block diagram of the recommended method of use of the second embodiment of the present invention. The steps are self explanatory and can be added to abbreviated or placed in different order depending on the learning environment, teacher preferences or student considerations.

1. A method of use of a teaching aid, comprising:
singing an ABC song with a child while drawing attention to a plurality of clusters of the teaching aid being recited in the song, each one of the plurality of clusters having, disposed on a substrate, at least a first element, consisting of a hand drawn object, a second element consisting of a hand drawn word corresponding to the hand drawn object, and a third element consisting of at least one mechanically reproduced letter corresponding to the hand drawn object and the hand drawn word;
directing the child first to the first element, then progressing to the second element, then ending at the third element for each cluster, wherein
a cluster appears for each letter of the alphabet and each of the clusters are arranged where the mechanically reproduced printed characters of the alphabet are in alphabetical order.

2. The method of claim 1, wherein the clusters are surrounded on at least two sides by a border.

3. The method of claim 1, further comprising arranging the two or more clusters side by side in an essentially horizontal line.

4. The method of claim 1, further comprising the step of coloring each of the first elements by the child.

5. A method of use of a teaching aid, comprising:
directing a child to one of a plurality of clusters disposed on a substrate of the teaching aid, each cluster having at least a first element, consisting of a hand drawn object, a second element consisting of a hand drawn word corresponding to the hand drawn object, and a third element consisting of at least one mechanically reproduced letter corresponding to the hand drawn object and the hand drawn word, wherein the child is first directed to the first object, then directed to the second object, then directed to the third object for each cluster; and
creating a space to define each of the clusters to direct the child's attention to one of the plurality of clusters at a time, wherein
a cluster appears for each letter of the alphabet and each of the clusters are arranged where the mechanically reproduced printed characters of the alphabet are in alphabetical order.

6. The method of claim 5, further comprising singing an ABC song with the child while drawing attention to the cluster of the teaching aid being recited in the song.

7. The method of claim 5, wherein the clusters are surrounded on at least two sides by a border.

8. The method of claim 5, further comprising arranging the two or more clusters side by side in an essentially horizontal line.

9. The method of claim 5, further comprising coloring each of the first elements by the child.
